(19) United States
(12) Patent Application Publication
(10) Pub. No.: US 2022/0213274 A1
(43) Pub. Date: Jul. 7, 2022

(54) Copolymer powder with polyamide blocks and polyether blocks

(71) Applicant: Arkema France, Colombes (FR)

(72) Inventors: Alexis MORFIN, SERQUIGNY (FR); Benoît BRULE, SERQUIGNY (FR); Apolline PALAIS, SERQUIGNY (FR); Nadine DECRAEMER, SERQUIGNY (FR)

(73) Assignee: Arkema France, Colombes (FR)

(21) Appl. No.: 17/610,830

(22) PCT Filed: May 15, 2020
(86) PCT No.: PCT/FR2020/050808

§ 371 Date: Nov. 12, 2021

(30) Foreign Application Priority Data
May 16, 2019 (FR) FR1905131

(51) Int. Cl. C08G 81/00; C08K 3/36; C08K 3/22; C08J 3/12; C08G 69/40; C09D 177/00; B33Y 10/00; B33Y 40/10; B33Y 70/00; B29C 64/153; B29C 64/314

(52) U.S. Cl. CPC C08G 81/00; C08K 3/36; C08K 3/22; C08J 3/12; C08G 69/40; C09D 177/00; B29K 2105/0085; B33Y 40/10; B33Y 70/00; B29C 64/153; B29C 64/314; C08K 2003/2227; C08J 2377/00; B33Y 10/00

(57) ABSTRACT

A powder of a copolymer with polyamide blocks and polyether blocks. The invention concerns a composition comprising a powder of a copolymer with polyamide blocks and polyether blocks, the copolymer being in particle form with a pulverulent filler content of 0 to 10% by mass and the copolymer having a ratio by mass of the polyamide blocks to the polyether blocks of less than or equal to 0.7, the polyamide blocks having a number-average molar mass of less than or equal to 1000 g/mol; and the composition comprising a flow aid at a content of greater than or equal to 0.3% by mass. The invention also concerns the process for producing this composition, the use of the composition for constructing three-dimensional articles, and the three-dimensional articles manufactured from said composition.

### FIELD OF THE INVENTION

The present invention relates to a powder composition of a copolymer comprising polyamide blocks and comprising polyether blocks, and also to its process of preparation. The invention also relates to the use of this powder and to the articles manufactured from it.

### TECHNICAL BACKGROUND

Copolymers comprising polyamide blocks and comprising polyether blocks or “Polyether-Block-Amides” (PEBAs) are plasticizer-free thermoplastic elastomers which belong to the family of engineering polymers. They can be easily processed by injection molding and extrusion of profiles or films. They can also be employed in the form of filaments, yarns and fibers for woven fabrics and nonwovens. They are used in the field of sport in particular as components of sports footwear soles or of golf balls, in the medical field in particular in catheters, angioplasty balloons, peristaltic belts, or in motor vehicles, in particular as synthetic leather, hides, dashboard, airbag component.

PEBAs, sold under the name Pebax® by Arkema, make it possible to combine, in one and the same polymer, unequalled mechanical properties with very good resistance to thermal or UV aging, and also a low density. They thus make possible the production of light and flexible parts. In particular, at equivalent hardness, they dissipate less energy than other materials, which confers on them a very good resistance to flexural or tensile dynamic stresses, and they exhibit exceptional elastic recovery properties.

These polymers can also be used in the field of the building of three-dimensional articles by sintering. According to this process, a layer of polymer powder is selectively and briefly irradiated in a chamber with electromagnetic radiation (for example laser beam, infrared radiation, UV radiation), the result being that the powder particles impacted by the radiation melt. The molten particles coalesce and solidify rapidly to result in the formation of a solid mass. This process can simply and quickly produce three-dimensional articles by repeated irradiation of a succession of freshly applied layers of powder. This technology is generally used to produce prototypes, models of parts (“rapid prototyping”) or to produce finished parts in small series (“rapid manufacturing”), for example in the motor vehicle, nautical, aeronautical or aerospace fields, in the medical field (prostheses, hearing systems, cell tissues), textiles, clothing and fashion, decoration, housings for electronics, telephony, home automation, computers, lighting.

Layer-by-layer sintering processes require a prior transformation of the PEBAs into the form of powders. These powders must be suitable for use in sintering devices and make possible the manufacture of flexible parts having satisfactory mechanical properties.

The quality of the manufactured parts and also their mechanical properties depend on the properties of the PEBA powder. For example, the agglomeration of the powder has to be avoided because it results in the manufacture of three-dimensional articles having a poor definition. In addition, the powder has be able to be conveyed and to form a uniform bed, without clumping or forming heaps or fissures. Otherwise, it cannot be transformed correctly. The addition of an additive, such as a flow agent, can improve the flow properties to some extent. However, when a high amount of flow agent is used, the coalescence of the powder requires a great deal of energy, which does not make it possible to have parts having both a good definition and good mechanical properties. In particular, they can decrease the elongation at break of the material.

The document FR 2 955 330 A1 relates to a thermoplastic powder composition with a D50 of less than 100 μm, comprising: at least one block copolymer with a melting point of less than 180° C., from 15% to 50% by weight of at least one pulverulent filler with a Mohs hardness of less than 6 and with a D50 of less than 20 μm, and from 0.1% to 5% of a pulverulent flow agent with a D50 of less than 20 μm. The document relates in particular to the use of said composition for manufacturing flexible three-dimensional objects. The use of pulverulent fillers makes it possible to facilitate the grinding and thus the obtaining of the desired particle size. However, the presence of the fillers at a high content in the manufactured parts adversely affects their mechanical properties.

EP 0 968 080 A1 relates to a thermoplastic powder comprising a mixture of powdered flow agent and of a powdered block copolymer thermoplastic resin having a glass transition temperature not exceeding 50° C. This powder can be used for the manufacture of flexible three-dimensional objects.

The document EP 1 845 129 A1 relates to a process for the manufacture of shaped articles from polymer powders by layer-by-layer sintering of the powder. The powder comprises at least one polyetheramide block prepared from oligoamide-dicarboxylic acids and polyetherdiamines.

There nevertheless still exists a real need to provide a PEBA powder composition making possible the building of three-dimensional articles by sintering in an efficient manner, in particular making it possible to work with a wider working window and at a relatively low build temperature, said articles being characterized by good mechanical properties, such as good flexibility. There also exists a need to provide a PEBA powder composition having good recyclability.

### SUMMARY OF THE INVENTION

The invention relates first to a composition comprising a powder of copolymer comprising polyamide blocks and comprising polyether blocks, the copolymer being in the form of particles having a content of pulverulent fillers of from 0% to 10% by weight and the copolymer having a ratio by weight of the polyamide blocks to the polyether blocks of less than or equal to 0.7, the polyamide blocks having a number-average molar mass of less than or equal to 1000 g/mol; and the composition comprising a flow agent at a content of greater than or equal to 0.3% by weight.

According to certain embodiments, the polyamide blocks have a number-average molar mass of less than or equal to 900 g/mol.

According to certain embodiments, the ratio by weight of the polyamide blocks to the polyether blocks is less than or equal to 0.65.

According to certain embodiments, the flow agent is present at a content of less than or equal to 2% by weight.

According to certain embodiments, the flow agent is chosen from silicas, in particular hydrated silicas, pyrogenic silicas, vitreous silicas or fumed silicas; alumina, in particular amorphous alumina; glassy phosphates, glassy borates, glassy oxides, titanium dioxide, calcium silicates, magnesium silicates, talc, mica, kaolin, attapulgite and their mixtures.

According to certain embodiments, the particles of the powder have a size Dv10 of greater than or equal to 30 μm and preferably of greater than or equal to 35 μm.

According to certain embodiments, the particles of the powder have a size Dv90 of less than or equal to 250 μm and preferably of less than or equal to 200 μm.

According to certain embodiments, the particles of the powder have a size Dv50 of from 80 to 150 μm and preferably of from 90 to 120 μm.

The sizes Dv10, Dv50 and Dv90 are measured according to ISO 13320:2009, for example by laser diffraction on a Malvern diffractometer by the dry route, and by modeling the distribution of the particles according to ISO 9276.

According to certain embodiments, the copolymer exhibits an instantaneous hardness as measured according to ISO 868:2003 of from 20 to 75 Shore D and preferably from 25 to 45 Shore D.

According to certain embodiments, the polyamide blocks of the copolymer are blocks of polyamide 11, or of polyamide 12, or of polyamide 6, or of polyamide 10.10, or of polyamide 10.12, or of polyamide 6.10; and/or the polyether blocks of the copolymer are blocks of polyethylene glycol, of polypropylene glycol or of polytetrahydrofuran.

According to certain embodiments, the polyamide blocks of the copolymer are blocks of polyamide 11, or of polyamide 12, or of polyamide 1010, or of polyamide 1012; and/or in which the polyether blocks of the copolymer are blocks of polyethylene glycol, of polypropylene glycol or of polytetrahydrofuran.

According to certain embodiments, the polyether blocks have a number-average molar mass of from 400 to 3000, preferably from 800 to 2200, g/mol.

The invention also relates to a process for the preparation of the composition described above, comprising:
the provision of a copolymer comprising polyamide blocks and comprising polyether blocks and the grinding of this, and
the bringing of the copolymer into contact with a flow agent.

According to certain embodiments, the copolymer is brought into contact with the flow agent before the grinding.

According to certain embodiments, the grinding is cryogenic grinding.

According to certain embodiments, the copolymer is provided in the form of granules.

According to certain embodiments, the particles resulting from the grinding are sieved, the sieve oversize being recycled to the grinding.

The invention also relates to the use of the composition described above for the layer-by-layer building of a three-dimensional article by sintering brought about by electromagnetic radiation.

The invention also relates to a three-dimensional article manufactured from the composition described above, preferably by layer-by-layer building by sintering brought about by electromagnetic radiation.

The present invention makes it possible to meet the need expressed above. It more particularly provides a PEBA powder composition making possible the building of three-dimensional articles by sintering in an efficient manner, in particular making it possible to work with a wider working window and at a relatively low build temperature, said articles being characterized by good mechanical properties, such as good flexibility. The composition according to the invention furthermore exhibits good recyclability.

By virtue of a content of pulverulent fillers in a content of 0% to 10% by weight in the PEBA particles, the three-dimensional articles can be obtained with good mechanical properties, in particular a high elongation at break. In addition, the content of pulverulent fillers of less than or equal to 10% by weight makes it possible to obtain three-dimensional articles with a good impact strength. This is because the presence of the pulverulent fillers in PEBA particles at a content of greater than 10% by weight can result in brittle three-dimensional articles thus having a reduced impact strength.

In addition, a ratio by weight of the polyamide blocks to the polyether blocks of less than or equal to 0.7 also makes it possible to obtain three-dimensional articles having the desired flexibility properties. Thus, the three-dimensional articles manufactured from the composition according to the invention exhibit a relatively low modulus of elasticity.

The presence of an amount of greater than or equal to 0.3% by weight of flow agent makes it possible to further improve the flow capability of the powder and also its recyclability, while preserving the good mechanical properties of the three-dimensional articles.

Finally, the fact that the polyamide blocks have a number-average molar mass of less than or equal to 1000 g/mol makes it possible to implement the building process at a relatively low working temperature, and to have a wide working window. In other words, the fact that the polyamide blocks have a number-average molar mass of less than or equal to 1000 g/mol makes it possible to have a powder composition in which the PEBA copolymer has a relatively low melting point which is sufficiently distant from the crystallization temperature, which subsequently makes it possible to work in a wide range of build temperature values.

Furthermore, the fact of preferably bringing the PEBA copolymer into contact with the flow agent before the grinding stage makes it possible to improve not only the efficiency (or yield) of the grinding but also the recycling of the polymer/flow agent mixture in order to increase the efficiency of the powder preparation process. More particularly, by virtue of the better flowability of this mixture, sieving can be carried out so as to recycle the coarsest particles to the mill.

### DETAILED DESCRIPTION

The invention is now described in greater detail and in a nonlimiting way in the description which follows.

Copolymer

The invention uses a copolymer comprising polyamide (PA) blocks and comprising polyether (PE) blocks, or “PEBA” copolymer.

PEBAs result from the polycondensation of polyamide blocks comprising reactive end groups with polyether blocks comprising reactive end groups, such as, inter alia, the polycondensation:

1) of polyamide blocks comprising diamine chain ends with polyoxyalkylene blocks comprising dicarboxyl chain ends;

2) of polyamide blocks comprising dicarboxyl chain ends with polyoxyalkylene blocks comprising diamine chain ends, which are obtained, for example, by cyanoethylation and hydrogenation of aliphatic α,ω-dihydroxylated polyoxyalkylene blocks, known as polyetherdiols;

3) of polyamide blocks comprising dicarboxyl chain ends with polyetherdiols, the products obtained being, in this specific case, polyetheresteramides.

Preferably, the PEBAs according to the invention are obtained by the polycondensation 2) or 3), and preferably by the polycondensation 3).

The polyamide blocks comprising dicarboxyl chain ends originate, for example, from the condensation of precursors of polyamides in the presence of a chain-limiting dicarboxylic acid. The polyamide blocks comprising diamine chain ends originate, for example, from the condensation of precursors of polyamides in the presence of a chain-limiting diamine.

Three types of polyamide blocks can advantageously be used.

According to a first type, the polyamide blocks originate from the condensation of a dicarboxylic acid, in particular those having from 4 to 20 carbon atoms, preferably those having from 6 to 18 carbon atoms, and of an aliphatic or aromatic diamine, in particular those having from 2 to 20 carbon atoms, preferably those having from 6 to 14 carbon atoms.

Mention may be made, as examples of dicarboxylic acids, of 1,4-cyclohexanedicarboxylic acid, butanedioic, adipic, azelaic, suberic, sebacic, dodecanedicarboxylic and octadecanedicarboxylic acids and terephthalic and isophthalic acids, but also dimerized fatty acids.

Mention may be made, as examples of diamines, of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), para-amino-dicyclohexylmethane (PACM), isophoronediamine (IPDA), 2,6-bis(aminomethyl)norbornane (BAMN) and piperazine (Pip).

Advantageously, polyamide blocks PA 412, PA 414, PA 418, PA 610, PA 612, PA 614, PA 618, PA 912, PA 1010, PA 1012, PA 1014 and PA 1018 are used. In the notation of the polyamides of PA XY type, X represents the number of carbon atoms resulting from the diamine residues and Y represents the number of carbon atoms resulting from the diacid residues, in a conventional way.

According to a second type, the polyamide blocks result from the condensation of one or more α,ω-aminocarboxylic acids and/or of one or more lactams having from 6 to 12 carbon atoms in the presence of a dicarboxylic acid having from 4 to 12 carbon atoms or of a diamine. Mention may be made, as examples of lactams, of caprolactam, oenantholactam and lauryllactam. Mention may be made, as examples of α,ω-aminocarboxylic acids, of aminocaproic acid, 7-aminoheptanoic acid, 11-aminoundecanoic acid and 12-aminododecanoic acid.

Advantageously, the polyamide blocks of the second type are PA 11 (polyundecanamide), PA 12 (polydodecanamide) or PA 6 (polycaprolactam) blocks. In the notation of the polyamides of PA X type, X represents the number of carbon atoms resulting from the amino acid (or lactam) residues.

According to a third type, the polyamide blocks result from the condensation of at least one α,ω-aminocarboxylic acid (or one lactam), at least one diamine and at least one dicarboxylic acid.

In this case, the polyamide PA blocks are prepared by polycondensation:
of the linear aliphatic or aromatic diamine(s) having X carbon atoms;
of the dicarboxylic acid(s) having Y carbon atoms; and
of the comonomer(s) {Z}, chosen from lactams and α,ω-aminocarboxylic acids having Z carbon atoms and equimolar mixtures of at least one diamine having X1 carbon atoms and of at least one dicarboxylic acid having Y1 carbon atoms, (X1, Y1) being different from (X, Y);
said comonomer(s) {Z} being introduced in a proportion by weight advantageously ranging up to 50%, preferably up to 20% and more advantageously still up to 10%, with respect to the combined polyamide precursor monomers;
in the presence of a chain-limiting agent chosen from dicarboxylic acids.

Use is advantageously made, as chain-limiting agent, of the dicarboxylic acid having Y carbon atoms, which is introduced in excess with respect to the stoichiometry of the diamine(s).

According to an alternative form of this third type, the polyamide blocks result from the condensation of at least two α,ω-aminocarboxylic acids or of at least two lactams having from 6 to 12 carbon atoms or of a lactam and of an aminocarboxylic acid not having the same number of carbon atoms, in the optional presence of a chain-limiting agent. Mention may be made, as examples of aliphatic α,ω-aminocarboxylic acids, of aminocaproic, 7-aminoheptanoic, 11-aminoundecanoic and 12-aminododecanoic acids. Mention may be made, as examples of lactams, of caprolactam, oenantholactam and lauryllactam. Mention may be made, as examples of aliphatic diamines, of hexamethylenediamine, dodecamethylenediamine and trimethylhexamethylenediamine. Mention may be made, as an example of cycloaliphatic diacids, of 1,4-cyclohexanedicarboxylic acid. Mention may be made, as examples of aliphatic diacids, of butanedioic, adipic, azelaic, suberic, sebacic and dodecanedicarboxylic acids, dimerized fatty acids. These dimerized fatty acids preferably have a dimer content of at least 98%; preferably, they are hydrogenated; they are, for example, the products sold under the Pripol brand by Croda, or under the Empol brand by BASF, or under the Radiacid brand by Oleon, and polyoxyalkylene-α,ω-diacids. Mention may be made, as examples of aromatic diacids, of terephthalic acid (T) and isophthalic acid (I). Mention may be made, as examples of cycloaliphatic diamines, of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-amino-dicyclohexylmethane (PACM). The other diamines commonly used can be isophoronediamine (IPDA), 2,6-bis(aminomethyl)norbornane (BAMN) and piperazine.

Mention may be made, as examples of polyamide blocks of the third type, of the following:
PA 66/6, where 66 denotes hexamethylenediamine units condensed with adipic acid and 6 denotes units resulting from the condensation of caprolactam;
PA 66/610/11/12, where 66 denotes hexamethylenediamine condensed with adipic acid, 610 denotes hexamethylenediamine condensed with sebacic acid, 11 denotes units resulting from the condensation of aminoundecanoic acid and 12 denotes units resulting from the condensation of lauryllactam.

The notations PA X/Y, PA X/Y/Z, and the like, relate to copolyamides in which X, Y, Z, and the like, represent homopolyamide units as described above.

Advantageously, the polyamide blocks of the copolymer used in the invention comprise blocks of polyamide PA 6, PA 11, PA 12, PA 54, PA 59, PA 510, PA 512, PA 513, PA 514, PA 516, PA 518, PA 536, PA 64, PA 69, PA 610, PA 612, PA 613, PA 614, PA 616, PA 618, PA 636, PA 104, PA 109, PA 1010, PA 1012, PA 1013, PA 1014, PA 1016, PA 1018, PA 1036, PA 10T, PA 124, PA 129, PA 1210, PA 1212, PA 1213, PA 1214, PA 1216, PA 1218, PA 1236, PA 12T, or mixtures or copolymers of these; and preferably comprise blocks of polyamide PA 6, PA 11, PA 12, PA 610, PA 1010, PA 1012, or mixtures or copolymers of these.

The polyether blocks consist of alkylene oxide units.

The polyether blocks can in particular be PEG (polyethylene glycol) blocks, that is to say consisting of ethylene oxide units, and/or PPG (propylene glycol) blocks, that is to say consisting of propylene oxide units, and/or PO3G (polytrimethylene glycol) blocks, that is to say consisting of polytrimethylene glycol ether units, and/or PTMG blocks, that is to say consisting of tetramethylene glycol, also called polytetrahydrofuran, units. The PEBA copolymers can comprise several types of polyethers in their chain, it being possible for the copolyethers to be block or random.

Use may also be made of blocks obtained by oxyethylation of bisphenols, such as, for example, bisphenol A. The latter products are described in particular in the document EP 613 919.

The polyether blocks can also consist of ethoxylated primary amines. Mention may be made, as examples of ethoxylated primary amines, of the products of formula:

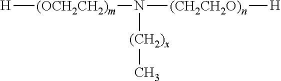

in which m and n are integers between 1 and 20 and x is an integer between 8 and 18. These products are, for example, commercially available under the Noramox® brand from CECA and under the Genamin® brand from Clariant. The polyether blocks can comprise polyoxyalkylene blocks comprising NH₂ chain ends, it being possible for such blocks to be obtained by cyanoacetylation of aliphatic α,ω-dihydroxylated polyoxyalkylene blocks, known as polyetherdiols. More particularly, use may be made of the Jeffamine or Elastamine commercial products (for example, Jeffamine® D400, D2000, ED 2003 or XTJ 542, commercial products from Huntsman, also described in the documents JP 2004346274, JP 2004352794 and EP 1 482 011).

The polyetherdiol blocks are either used as is and copolycondensed with polyamide blocks having carboxyl end groups, or aminated in order to be converted into polyetherdiamines and condensed with polyamide blocks having carboxyl end groups.

A general method for the two-stage preparation of PEBA copolymers having ester bonds between the PA blocks and the PE blocks is known and is described, for example, in the document FR 2 846 332. A general method for the preparation of PEBA copolymers having amide bonds between the PA blocks and the PE blocks is known and described, for example, in the document EP 1 482 011. The polyether blocks can also be mixed with polyamide precursors and a chain-limiting diacid in order to prepare polymers comprising polyamide blocks and polyether blocks having randomly distributed units (one-stage process).

Of course, the designation PEBA in the present description of the invention relates just as well to the PEBAX® products sold by Arkema, to the Vestamid® products sold by Evonik®, to the Grilamid® products sold by EMS, as to the PEBA-type Pelestat® products sold by Sanyo or to any other PEBA from other suppliers.

While the block copolymers described above generally comprise at least one polyamide block and at least one polyether block, the present invention also covers all the copolymers comprising two, three, four (indeed even more) different blocks chosen from those described in the present description, provided that these blocks comprise at least polyamide and polyether blocks. For example, the copolymer according to the invention can comprise a segmented block copolymer comprising three different types of blocks (or “triblock” copolymer), which results from the condensation of several of the blocks described above. Said triblock is preferably chosen from copolyetheresteramides and copolyetheramideurethanes.

PEBA copolymers which are particularly preferred in the context of the invention are the copolymers comprising:
PA 11 and PEG blocks;
PA 11 and PTMG blocks;
PA 12 and PEG blocks;
PA 12 and PTMG blocks;
PA 610 and PEG blocks;
PA 610 and PTMG blocks;
PA 1010 and PEG blocks;
PA 1010 and PTMG blocks;
PA 1012 and PEG blocks;
PA 1012 and PTMG blocks;
PA 6 and PEG blocks;
PA 6 and PTMG blocks.

The number-average molar mass of the polyamide blocks in the PEBA copolymer is less than or equal to 1000 g/mol and preferably less than or equal to 900 g/mol.

Thus, the polyamide blocks in the PEBA copolymer can have a number-average molar mass of from 100 to 200 g/mol; or from 200 to 300 g/mol; or from 300 to 400 g/mol; or from 400 to 500 g/mol; or from 500 to 600 g/mol; 600 to 700 g/mol; or from 700 to 800 g/mol; or 800 to 900 g/mol; or from 900 to 1000 g/mol.

In certain embodiments, the number-average molar mass of the polyether blocks in the PEBA copolymer has a value from 250 to 2000 g/mol, preferably from 400 to 2000 g/mol, and for example more preferably from 800 to 1500 g/mol.

Thus, the polyether blocks in the PEBA copolymer can have a number-average molar mass of from 250 to 300 g/mol; or from 300 to 400 g/mol; or from 400 to 500 g/mol; or from 500 to 600 g/mol; or from 600 to 700 g/mol; or from 700 to 800 g/mol; or 800 to 900 g/mol; or from 900 to 1000 g/mol; or 1000 to 1500 g/mol; or from 1500 to 2000 g/mol.

The number-average molar mass is set by the content of chain-limiting agent.

It can be calculated according to the relationship:

Mₙ=nₘₒₙₒₘₑᵣ×MW_{repeat unit}/n_{chain-limiting agent}+MW_{chain-limiting agent}

In this formula, nₘₒₙₒₘₑᵣ represents the number of moles of monomer, n_{chain-limiting agent} represents the number of moles of excess chain-limiting agent (e.g. diacid), MW_{repeat unit} represents the molar mass of the repeat unit, and MW_{chain-limiting agent} represents the molar mass of the excess chain-limiting agent (e.g. diacid).

The number-average molar mass of the polyamide blocks and of the polyether blocks can be measured before the copolymerization of the blocks by gel permeation chromatography (GPC).

The ratio by weight of the polyamide blocks with respect to the polyether blocks of the PEBA copolymer is less than or equal to 0.7, and preferably less than or equal to 0.65. This ratio by weight can be calculated by dividing the number-average molar mass of the polyamide blocks by the number-average molar mass of the polyether blocks.

Thus, the ratio by weight of the polyamide blocks with respect to the polyether blocks of the PEBA copolymer can be from 0.1 to 0.2; or from 0.2 to 0.3; or from 0.3 to 0.4; or from 0.4 to 0.5; or from 0.5 to 0.6; or from 0.6 to 0.7.

Preferably, the copolymer used in the invention exhibits an instantaneous hardness of from 20 to 75 Shore D and preferably from 25 to 45 Shore D. The hardness measurements can be carried out according to the standard ISO 868:2003.

The implementation of the invention is particularly advantageous with a relatively flexible PEBA copolymer, insofar as the particles of such a copolymer have an increased tendency toward agglomeration.

The PEBA copolymer can exhibit a glass transition temperature of less than or equal to 0° C., preferably of less than or equal to −20° C., more preferably of less than or equal to −40° C. and more preferably of less than or equal to −50° C. This temperature is measured by dynamic mechanical analysis (DMA) according to the standard ISO 6721-11:2012.

Process for the Manufacture of the Copolymer Powder

To start with, the process according to the invention comprises the provision of a PEBA copolymer as described above. According to certain embodiments, it is possible to use a mixture of two or more than two PEBA copolymers as described above. However, it is preferred to use a single PEBA copolymer as described above. The PEBA copolymer(s) can, for example, be in the form of granules. Alternatively, the PEBA copolymer(s) can be in the form of flakes or of a coarse powder, for example having a size Dv50 of greater than 250 μm. The PEBA copolymer is subsequently brought into contact with a flow agent in order to form a mixture—preferably before the grinding stage.

The term “flow agent” is understood to mean an agent which makes it possible to improve the flowability as well as the leveling of the copolymer powder during the sintering process. The flow agent can be chosen from those commonly used in the field of the sintering of polymer powders. Preferably, this flow agent is of substantially spherical shape. It is, for example, chosen from silicas, in particular hydrated silicas, pyrogenic silicas, vitreous silicas or fumed silicas; alumina, in particular amorphous alumina; glassy phosphates, glassy borates, glassy oxides, titanium dioxide, calcium silicates, magnesium silicates, talc, mica, kaolin, attapulgite and their mixtures.

The flow agent is in the form of particles having a mean size (Dv50) of less than or equal to 10 μm and more preferably of less than or equal to 1 μm. For example, the size Dv50 of the particles of the flow agent can be from 10 nm to 100 nm, from 100 nm to 1 μm, from 1 μm to 10 μm.

In the context of the present patent application:
the Dv10 corresponds to the threshold of the particle size for which 10% of the particles (by volume) have a size of less than the threshold, and 90% of the particles (by volume) have a size of greater than the threshold;
the Dv50 corresponds to the threshold of the particle size for which 50% of the particles (by volume) have a size of less than the threshold, and 50% of the particles (by volume) have a size of greater than the threshold;
the Dv90 corresponds to the threshold of the particle size for which 90% of the particles (by volume) have a size of less than the threshold, and 10% of the particles (by volume) have a size of greater than the threshold.

The Dv10, the Dv50 and the Dv90 are measured according to ISO 13320:2009, for example by laser diffraction on a Malvern diffractometer by the dry route, and the distribution of the particles is modeled according to the standard ISO 9276—parts 1 to 6: “Representation of results of particle size analysis”.

The flow agent is added to the PEBA copolymer in a proportion of greater than or equal to 0.3% by weight, with respect to the total weight of the final composition.

The flow agent added to the copolymer can have a content of less than or equal to 3% by weight, with respect to the total weight of the final composition, preferably of less than or equal to 2% by weight. Thus, the flow agent can be added in a proportion of from 0.3% to 0.4%; or from 0.4% to 0.5%; or from 0.5% to 0.6%; or from 0.6% to 0.7%; or from 0.7% to 0.8%; or from 0.8% to 0.9%; or from 0.9% to 1%; or from 1% to 1.1%; or from 1.1% to 1.2%; or from 1.2% to 1.3%; or from 1.3% to 1.4%; or from 1.4% to 1.5%; or from 1.5% to 1.6%; or from 1.6% to 1.7%; or from 1.7% to 1.8%; or from 1.8% to 1.9%; or from 1.9% to 2%; or from 2% to 2.5%; or 2.5% to 3.0%.

The PEBA copolymer, preferably premixed with the flow agent, subsequently undergoes a grinding stage in order to obtain a powder with the desired particle size.

Preferably, the grinding is a cryogenic grinding. Thus, to start with, the mixture of copolymer and of flow agent is cooled to a temperature lower than the glass transition temperature of the copolymer. This temperature can be from 10 to 50° C. lower than the glass transition temperature of the copolymer. Thus, the mixture can be cooled to a temperature of less than or equal to −10° C., preferably of less than or equal to −50° C., and more preferably of less than or equal to −80° C. This temperature can be from −10 to −20° C.; or from −20 to −30° C.; or from −30 to −40° C.; or from −40 to −50° C.; or from −50 to −60° C.; or from −60 to −70° C.; or from −70 to −80° C.; or from −80 to −90° C.; or from −90 to −100° C. The cooling of the mixture of copolymer and of flow agent can be carried out, for example, with liquid nitrogen, or with liquid carbon dioxide or with dry ice, or with liquid helium.

Preferably the grinding stage is carried out in a mill with counter-rotating pins (pin mill). Thus, the mill comprises a first series of brushes rotating in one direction and a second series of brushes rotating in the opposite direction. This makes it possible to increase the speed and thus the energy of the impact. Preferably, these pins can be fluted, which makes possible a greater impact on the particles to be ground.

Alternatively, the grinding stage can be carried out in a hammer mill or in a whirl mill.

The mill used can comprise a sieve onto which the ground particles are directed. The sieve exhibits pores (screen openings) making possible the retention of particles having a greater size than the pores of the sieve, on the one hand, and the passage of particles having a smaller size than the pores of the sieve, on the other hand. When the pores do not have a circular opening, the term “diameter” of the pores is understood to mean the maximum distance between two points occurring in a plane parallel to the opening. For example, for pores having a rectangular or square opening, the diameter denotes the diagonal of each opening. The sieve can, for example, have pores with a diameter of less than or equal to 300 μm, or of less than or equal to 250 μm, and preferably of less than or equal to 200 μm. The diameter of the pores can, for example, be from 100 to 120 μm, 120 to 150 μm; or from 150 to 200 μm; or from 200 to 250 μm; or from 250 to 300 μm.

Thus, the particles with a size greater than that desired for the preparation of the powder can be retained on the sieve while the particles with a suitable particle size can pass through the sieve.

The particles retained on the sieve can subsequently be led to the mill so that they are recycled and undergo further grinding.

Preferably, the recycling of the particles is continuous during the grinding stage.

Preferably, a single grinding stage is carried out.

After grinding, a certain particle size fraction of the powder can be selected, in order to obtain the particle size profile desired in the invention. Thus, the powders are dispersed by a selection wheel and transported by classification air. The dust entrained in the air is conveyed through a support wheel and discharged via a first outlet. The coarse product is rejected by a classifying wheel and transported to a second outlet. The selector can comprise several successive wheels working in parallel.

PEBA Powder Composition

The composition according to the invention comprises particles of PEBA copolymer and particles of the flow agent.

The particles of the composition according to the invention can have a size Dv10 of greater than or equal to 30 μm and preferably of greater than or equal to 35 μm. For example, the size Dv10 of the particles of the composition can be from 30 to 35 μm; or from 35 to 40 μm; or from 40 to 45 μm; or from 45 to 50 μm.

A size Dv10 of greater than or equal to 30 μm makes it possible to avoid the problems related to the density and also the flow capability of the powder. Thus, advantageously, the use of a powder of the particles having a size Dv10 of greater than or equal to 30 μm makes it possible to obtain a bed of powder of good quality and consequently articles having a good definition of the edges and of the contours.

The use of a powder having a size Dv10 of greater than 30 μm makes possible lower agglomeration of the powder in a three-dimensional printing machine and thus better recycling.

The amount of flow agent in the composition can be adapted as a function of the particle size of the powder. Generally, the lower the Dv10 of the powder, the greater the amount of flow agent in the powder has to be in order to preserve the flowability and the mechanical properties of the manufactured parts.

The particles of the composition according to the invention can also have a size Dv90 of less than or equal to 250 μm and preferably of less than or equal to 200 μm. For example, the size Dv90 of the particles of the composition can be from 150 to 160 μm; or from 160 to 170 μm; or from 170 to 180 μm; or from 180 to 190 μm; or from 190 to 200 μm; or from 200 to 210 μm; or from 210 to 220 μm; or from 220 to 230 μm; or from 230 to 240 μm; or from 240 to 250 μm. A size Dv90 of less than or equal to 250 μm also makes it possible to obtain articles having a good definition of the edges and of the contours. This is because particles having a size Dv90 of greater than 250 μm might result in articles exhibiting a poor definition in view of the layer thickness which is used during the sintering process.

Furthermore, the particles of the composition according to the invention can have a size Dv50 of from 80 to 150 μm and preferably from 100 to 150 μm. For example, the size Dv50 of the particles of the composition can be from 80 to 85 μm; or from 85 to 90 μm; or from 90 to 95 μm; or from 95 to 100 μm; or from 100 to 105 μm; or from 105 to 110 μm; or from 110 to 115 μm; or from 115 to 120 μm; or from 120 to 125 μm; or from 125 to 130 μm; or from 130 to 135 μm; or from 135 to 140 μm; or from 140 to 145 μm; or from 145 to 150 μm. The composition according to the invention can comprise the PEBA copolymer(s) in a proportion by weight preferably of greater than or equal to 80%, or greater than or equal to 81%, or greater than or equal to 82%, or greater than or equal to 83%, or greater than or equal to 84%, or greater than or equal to 85%, or greater than or equal to 86%, or greater than or equal to 87%, or greater than or equal to 88%, or greater than or equal to 89%, or greater than or equal to 90%, or greater than or equal to 91%, or greater than or equal to 92%, or greater than or equal to 93%, or greater than or equal to 94%, or greater than or equal to 95%, or greater than or equal to 96%, or greater than or equal to 97%, or greater than or equal to 98%, or greater than or equal to 99%, or greater than or equal to 99.1%, or greater than or equal to 99.2%, or greater than or equal to 99.3%, or greater than or equal to 99.4%, or greater than or equal to 99.5%, or greater than or equal to 99.6%, or greater than or equal to 99.7%, or greater than or equal to 99.8%, or greater than or equal to 99.9%, or greater than or equal to 99.91%, or greater than or equal to 99.92%, or greater than or equal to 99.93%, or greater than or equal to 99.94%, or greater than or equal to 99.95%, or greater than or equal to 99.96%, or greater than or equal to 99.97%, or greater than or equal to 99.98%, or greater than or equal to 99.99%.

The flow agent is present in the composition at a content of greater than or equal to 0.3% by weight of the composition. Preferably, the flow agent present in the composition can have a content of less than or equal to 2% by weight of the composition. Thus, this content can be from 0.3% to 0.4%; or from 0.4% to 0.5%; or from 0.5% to 0.6%; or from 0.6% to 0.7%; from 0.7% to 0.8%; or from 0.8% to 0.9%; or from 0.9% to 1%; or from 1% to 1.1%; or from 1.1% to 1.2%; or from 1.2% to 1.3%; or from 1.3% to 1.4%; or from 1.4% to 1.5%; or from 1.5% to 1.6%; or from 1.6% to 1.7%; or from 1.7% to 1.8%; or from 1.8% to 1.9%; or from 1.9% to 2%.

The PEBA powder in the composition can have an apparent specific surface of less than 2 m²/g.

The PEBA particles in the composition can comprise pulverulent fillers at a content of from 0% to 10% by weight of the composition. When they are present, these pulverulent fillers can be incorporated in the PEBA particles by compounding, in particular at the step of the manufacture of the granules intended to be ground.

The composition can thus additionally comprise from 0% to 10% by weight of pulverulent fillers, with respect to the total weight of the composition.

The term “pulverulent filler” is understood to mean a compound in the powder form with a mean size (Dv₅₀) of greater than 10 μm, in particular of greater than 20 μm, which makes it possible to modify the mechanical properties (for example modulus, elongation at break, impact strength) of the three-dimensional parts manufactured.

Examples of pulverulent fillers are carbonate-comprising inorganic fillers, in particular calcium carbonate, magnesium carbonate, dolomite or calcite, barium sulfate, calcium sulfate, dolomite, alumina hydrate, wollastonite, montmorillonite, zeolite or perlite, organic fillers, such as polymer powders having a melting point which is greater than the maximum temperature endured by the composition during the layer-by-layer building process, in particular such polymer powders with a modulus of greater than 1000 MPa.

According to certain preferred embodiments, the PEBA particles of the composition of the invention are devoid of pulverulent fillers.

According to certain preferred embodiments, the composition according to the invention is devoid of pulverulent fillers.

Alternatively, if pulverulent fillers are present in the PEBA particles, they are present at a content by weight of less than or equal to 10%, preferably of less than or equal to 5%, more preferably of less than or equal to 1%. For example, the pulverulent fillers can be present in the PEBA particles at a content by weight of from 0.05% to 1%; or from 1% to 2%; or from 2% to 3%; or from 3% to 4%; or from 4% to 5%; or from 5% to 6%; or from 6% to 7%; or from 7% to 8%; or from 8% to 9%; or from 9% to 10%.

The total content by weight of pulverulent fillers (when they are present) in the composition (including those present, if appropriate, in the PEBA particles) is preferably less than or equal to 10%, preferably less than or equal to 5%, more preferably less than or equal to 1%.

The composition according to the invention can comprise, in addition to the flow agent and the pulverulent fillers already mentioned, any type of other additive suitable for the polymer powders used in sintering: in particular additives (in or not in powder form) which contribute to improving the properties of the powder for its use in agglomeration technology and/or additives making it possible to improve the properties, for example esthetic (color) properties, of the objects obtained by fusion. The composition of the invention can in particular comprise dyes, pigments for coloring, TiO₂, pigments for infrared absorption, carbon black, fireproofing additives, glass fibers, carbon fibers and the like. The composition of the invention can additionally contain at least one additive chosen from stabilizers, antioxygen, light stabilizers, impact modifiers, antistatic agents, flame retardants and their mixtures. These additives are preferably in the form of a powder having a Dv50 of less than 20 μm and in particular of less than 10 μm. Advantageously, the additives in the powder form have a Dv of greater than 100 nm and very particularly of greater than 1 μm. These additives can be present in the composition at a content by weight of 0.05% to 5%.

Preferably, the additives comprise one or more pigments.

The additives can be mixed with the PEBA copolymer before and/or after the grinding stage described above.

In certain embodiments, the powder composition can have a crystallization temperature of the polyamide blocks of from 40 to 160° C. and preferably from 50 to 100° C. The composition can in particular have a crystallization temperature of the polyamide blocks of from 40 to 50° C.; or from 50 to 60° C.; or from 60 to 70° C.; or from 70 to 80° C.; or from 80 to 90° C.; or from 90 to 100° C.; or from 100 to 110° C.; or from 110 to 120° C.; or from 120 to 130° C.; or from 130 to 140° C.; or from 140 to 150° C.; or from 150 to 160° C. The crystallization temperature can be measured by differential scanning calorimetry according to the standard ISO 11357-3.

The PEBA copolymer can have a melting point of less than or equal to 150° C. and preferably of less than or equal to 140° C. The PEBA copolymer can in particular have a melting point of from 100 to 105° C.; or from 105 to 110° C.; or from 110 to 115° C.; or from 115 to 120° C.; or from 120 to 125° C.; or from 125 to 130° C.; or from 130 to 135° C.; or from 135 to 140° C.; or from 140 to 145° C.; or from 145 to 150° C. The melting point can be measured by differential scanning calorimetry according to the standard ISO 11357-3.

A melting point of less than or equal to 150° C. makes it possible to decrease the heating time and also the energy consumption during the process for the layer-by-layer building of three-dimensional articles by sintering, which makes it possible to improve the efficiency of the process for the preparation of such articles.

The difference between the crystallization temperature and the melting point is preferably greater than or equal to 30° C., more preferably greater than or equal to 40° C., or greater than or equal to 50° C., or greater than or equal to 60° C., or greater than or equal to 70° C., or greater than or equal to 80° C.

The powder composition according to the invention can have a pourability of 2 to 10 seconds. The pourability can be measured according to the standard ISO 6186: 1998(E) Method A; 25 mm hole at 23° C.

Process for Sintering the Powder

The PEBA powder, as described above, is used for a process for the layer-by-layer building of three-dimensional articles by sintering brought about by electromagnetic radiation.

The electromagnetic radiation can, for example, be infrared radiation, ultraviolet radiation or, preferably, laser radiation.

According to the process, a thin layer of powder is deposited on a horizontal plate maintained in a chamber heated to a temperature called the build temperature. The term “build temperature” denotes the temperature to which the bed of powder, of a constituent layer of a three-dimensional object under build-up, is heated during the process for the layer-by-layer sintering of the powder. This temperature can be lower than the melting point of the PEBA copolymer by less than 100° C., preferably by less than 40° C. and more preferably by 20° C. approximately. The electromagnetic radiation subsequently contributes the energy necessary to sinter the powder particles at different points of the powder layer according to a geometry corresponding to an object (for example using a computer having in memory the shape of an object and recreating the latter in the form of slices).

Subsequently, the horizontal plate is lowered by a value corresponding to the thickness of a powder layer, and a fresh layer is deposited. The electromagnetic radiation contributes the energy necessary to sinter the powder particles according to a geometry corresponding to this new slice of the object, and so on. The procedure is repeated until the object has been manufactured.

Preferably, the powder layer deposited on a horizontal plate (before sintering) can have a thickness of from 20 to 200 μm and preferably from 50 to 150 μm. The layer of agglomerated material, after sintering, can have a thickness of from 10 to 150 μm and preferably from 30 to 100 μm.

The powder composition, as described above, can be recycled and reused in several successive build-ups. It can, for example, be used as it is or as a mixture with other powders, which are or are not recycled.

Thus, the powder composition can be recycled (that is to say, used in more than one build-up) once, or twice, or three times, or four times, or five times, or more than five times.

The three-dimensional articles manufactured can exhibit an elongation at break of greater than or equal to 200%, preferably of greater than or equal to 400% and more preferably of greater than or equal to 500%. The term “elongation at break” is understood to mean the ability of a material to become elongated before breaking when it is placed under tensile stress. The elongation at break can be measured according to the standard ISO 527 1A.

The three-dimensional articles manufactured can advantageously exhibit a modulus of elasticity of less than or equal to 100 MPa and more preferably of less than or equal to 70 MPa, or of less than or equal to 50 MPa; it can, for example, be from 1 to 100 MPa, preferably from 10 to 70 MPa. The modulus of elasticity can be measured according to the standard ISO 527 1:2019.

The powder composition according to the invention thus makes it possible to manufacture three-dimensional articles of good quality, having good mechanical properties and precise and well-defined dimensions and contours.

### EXAMPLES

The following examples illustrate the invention without limiting it. Unless otherwise indicated, the percentages indicated refer to percentages by weight with respect to the complete formulation.

### Example 1

In this example, a powder of PEBA copolymer (PA11 blocks of 600 g/mol, PTMG blocks of 1000 g/mol, ratio by weight PA11/PTMG=0.6, Tm=135° C., formulated with 0.8% by weight of stabilizing additives) having a size Dv10 of 21 μm, a size Dv50 of 48 μm and a size Dv90 of 100 μm (devoid of fillers) is mixed in a rapid mixer with different contents by weight of the following flow agent:

Agent 1: pyrogenic silica with a mean size of less than 0.1-0.3 μm and with a specific surface of 50 m²/g, dimethyldichlorosilane treatment, TS610 sold by Cabot Corporation),

Agent 2: pyrogenic silica with a mean size of less than 1 μm and with a specific surface of 220 m²/g (CT1221 sold by Cabot Corporation), and

Agent 3: pyrogenic alumina with a mean size of 7 to 40 nm and with a specific surface of greater than 50 m²/g (BET) (Alumina C sold by Evonik).

The pourability of these mixtures having holes with diameters of 25 mm and 15 mm and also the apparent and tamped densities are measured (pourability according to the standard ISO 6186: 1998(E) Method A, 23° C., tamping volumeter with the standards DIN ISO 787 Part 11:1981, 2500 taps on the graduated measuring cylinder for the tamped density).

TABLE 1

| | | Pourability (s) | | Density (g/cm³) | |
|---|---|---|---|---|---|
| Formulation | | 25 mm | 15 mm | apparent | tamped |
| PEBA powder alone | | DNP | DNP | 0.19 | 0.26 |
| Agent 1 | 0.1% | DNP | DNP | 0.28 | 0.36 |
| | 0.2% | 9 | DNP | 0.30 | 0.41 |
| | 0.3% | 7 | DNP | 0.31 | 0.42 |
| | 0.4% | 7 | 18 | 0.32 | 0.44 |
| Agent 2 | 0.1% | DNP | DNP | 0.28 | 0.36 |
| | 0.2% | 9 | DNP | 0.30 | 0.39 |
| | 0.3% | 9 | DNP | 0.31 | 0.42 |
| | 0.4% | 8 | 16 | 0.32 | 0.44 |
| Agent 3 | 0.1% | DNP | DNP | 0.23 | 0.32 |
| | 0.2% | DNP | DNP | 0.26 | 0.37 |
| | 0.3% | 10 | DNP | 0.30 | 0.39 |
| | 0.4% | 9 | DNP | 0.30 | 0.40 |

DNP = Does Not Pour

It is observed that the mixtures having a content of flow agent of greater than or equal to 0.3% by weight give better results. More particularly, a good pourability can be characterized in particular by a pourability through a funnel with a diameter of 15 mm and a funnel with a diameter of 25 mm, which makes it possible to have good supplying of the powder. This also makes it possible to have sufficient spreading to obtain a powder bed of good quality before and during the sintering and also sufficient flow to fill the cavities of the parts after laser passage. The mixtures with a content of flow agent of greater than or equal to 0.3% by weight also make it possible to improve the apparent and tamped density, in comparison with the PEBA powder alone.

### Example 2

In this example, a PEBA powder (same characteristics as in example 1) but having a size Dv10 of 42 μm, a size Dv50 of 106 μm and a size Dv90 of 178 μm (devoid of fillers) is mixed in a rapid mixer with different contents by weight of a flow agent (TS610 sold by Cabot Corporation).

TABLE 2

| | | Pourability (s) | | | Density (g/cm³) | |
|---|---|---|---|---|---|---|
| Formulation | | 25 mm | 15 mm | 10 mm | apparent | tamped |
| PEBA powder alone | | DNP | DNP | DNP | 0.33 | 0.43 |
| Agent 1 | 0.3% | 3.4 | 12.1 | 36.4 | 0.41 | 0.50 |
| | 1.0% | 2.7 | 9.7 | 29.0 | 0.44 | 0.56 |

It is observed that, when the PEBA copolymer powder has, as in this example, a size Dv10 of greater than 30 μm, a size Dv50 of between 50 and 150 μm and a size Dv90 of less than 250 μm, the flow capability and also the apparent and tamped density are also improved in comparison with a PEBA powder alone.

### Example 3

In this example, a PEBA powder (same characteristics as in example 1) and 0.3% by weight of a flow agent (TS610 sold by Cabot Corporation) are mixed. The flow agent is added to the PEBA granules before the grinding, in order to obtain the powder. The powder obtained has a Dv10 of 24 μm, a Dv50 of 73 μm and a Dv90 of 217 μm (Composition A). A selection was subsequently carried out on a CFS 5 HD-S selector (Netzsch) with an incoming flow rate of 2 kg/h and by setting a speed of rotation such that a powder with a Dv10 of 38 μm, a Dv50 of 88 μm and a Dv90 of 231 μm is obtained (Composition B).

The following test was carried out on the two compositions and the results are illustrated in table 3 below. The two compositions are poured in the same way into two metal cylinders with a diameter of 5 cm and a height of 3 cm. The cylinders containing the compositions are subsequently placed in an oven for 4 h at a temperature lower than the melting point of the PEBA copolymer by 20° C. (115° C.). The cylinders are taken out of the oven and left to cool to ambient temperature (23° C.) for 4 h.

A needle with a diameter of 1 mm ballasted with a weight of 500 g is subsequently dropped at various places of the surface of the powder. By measuring the depth to which the needle sinks, it is possible to evaluate the cohesion of the powders after the 4 h at a temperature lower than the melting point of the PEBA copolymer by 20° C. and the 4 h of cooling to ambient temperature. The less the needle sinks and the more the powder has stuck with itself in the oven, the more difficult it will be to recycle it.

TABLE 3

| Compositions | A | B |
|---|---|---|
| Depth of the needle (mm) | 9.4 | 11.1 |

It is observed that the needle sinks more deeply into the composition B having a Dv10 of greater than 30 μm, which means that this powder sticks less and that it will thus be easier to recycle it.

### Example 4

PEBA granules devoid of fillers (PA12 blocks of 850 g/mol, PTMG blocks of 2000 g/mol, ratio by weight PA12/PTMG=0.425, formulated with 0.2% by weight of stabilizing additives) are ground with a Mikropul 2DH hammer mill under cryogenic conditions. This powder composition (C) obtained after grinding has a size Dv10 of 66 μm, a size Dv50 of 157 μm and a size Dv90 of 292 μm.

In the same way, the same PEBA granules premixed with 1.0% by weight of flow agent (TS610 sold by Cabot Corporation) are introduced into the mill under the same conditions. This powder composition (D) obtained after grinding has a size Dv10 of 60 μm, a size Dv50 of 137 μm and a size Dv90 of 247 μm. It is found that the powder composition D has a reduced Dv90 in comparison with the powder composition C.

### Example 5

The following powders are tested:
EC1 (comparative): PA12 powder (PEBA 2301 Primepart ST sold by EOS).
EC2 (comparative): PA12/PPG PEBA powder with a size of PA12 blocks of 1068 g/mol, a size of PPG blocks of 2000 g/mol and a PA12/PPG ratio of approximately 0.53.
EC3 (comparative): PA12/PEG PEBA powder with a size of PA12 blocks of 1500 g/mol, a size of PEG blocks of 1500 g/mol and a PA12/PEG ratio of 1.
EC4 (comparative): PA12/PTMG PEBA powder with a size of PA12 blocks of 1000 g/mol, a size of PTMG blocks of 1000 g/mol and a PA12/PTMG ratio of 1.
EC5 (comparative): PA11/PTMG PEBA powder with a size of PA11 blocks of 1000 g/mol, a size of PTMG blocks of 1000 g/mol and a PA11/PTMG ratio of 1.
E1 (invention): PA12/PTMG PEBA powder with a size of PA12 blocks of 850 g/mol, a size of PTMG blocks of 2000 g/mol and a PA12/PTMG ratio of 0.43.
E2 (invention): PA11/PTMG PEBA powder with a size of PA11 blocks of 600 g/mol, a size of PTMG blocks of 1000 g/mol and a PA11/PTMG ratio of 0.6.
E3 (invention): PA12/PTMG PEBA powder with a size of PA12 blocks of 600 g/mol, a size of PTMG blocks of 2000 g/mol and a PA12/PTMG ratio of 0.3.
E4 (invention): PA11/PTMG PEBA powder with a size of PA11 blocks of 600 g/mol, a size of PTMG blocks of 2000 g/mol and a PA11/PTMG ratio of 0.3.

The PEBAs based on PA 12 are formulated with 0.2% by weight of stabilizing additives and those based on PA11 with 0.8% by weight of stabilizing additives. All these powders are devoid of filler.

The differential scanning calorimetry (DSC) analysis at 20° C./min (standard conditions) of these powders, and also a measurement of the modulus of elasticity of parts manufactured by injection molding starting from these powders, gave the following results:

TABLE 4

| | | | | | Modulus |
|---|---|---|---|---|---|
| | | | | | injection |
| | | | | | molding |
| Name | PA (g/mol) | PA/PE | Tm (° C.) | Tm-Tc | (MPa) |
| EC1 | — | — | 185 | 40 | 1200 |
| EC2 | 1068 | 0.53 | 153 | 33 | 80 |
| EC3 | 1500 | 1.0 | 159 | 59 | 80 |
| EC4 | 1000 | 1.0 | 147 | 53 | 81 |
| EC5 | 1000 | 1.0 | 147 | 43 | 75 |
| E1 | 850 | 0.43 | 144 | 82 | 18 |
| E2 | 600 | 0.6 | 135 | 72 | 40 |
| E3 | 600 | 0.3 | 135 | 88 | 10 |
| E4 | 600 | 0.3 | 133 | 85 | 20 |

It is observed that, when the ratio by weight of the polyamide blocks to the polyether blocks in the PEBA is less than or equal to 0.7 and when the polyamide blocks have a number-average molar mass of less than or equal to 1000 g/mol (E1 to E4), the melting points of the PEBA copolymer are lower (with respect to EC1 to EC5) and sufficiently distant from the crystallization temperatures, which subsequently makes it possible to work in a wide range of build temperature values, in a layer-by-layer building process.

It is also observed that the tensile moduli measured on an injection-molded part which are obtained are less than 50 MPa, which means to them that the powders of the invention confer good mechanical properties and in particular a good flexibility.

The modulus is measured according to the standard ISO 527-1/2.

The moduli of the sintered parts can vary with respect to those of the injection-molded parts. This is due to a greater crystallization of the sintered three-dimensional objects which remain between Tm and Tc longer than in injection molding. However, the relative comparison of the moduli of elasticity obtained in injection molding is representative of the relative comparison of the moduli of elasticity obtained in sintering. The invention thus makes it possible to obtain three-dimensional articles exhibiting moduli of elasticity of less than or equal to 70 MPa (preferably of less than or equal to 50 MPa).

### Example 6

A PEBA powder (with PA11 blocks with a size of 600 g/mol, PTMG blocks with a size of 1000 g/mol and a PA11/PTMG ratio by weight of 0.6) having a size Dv10 of 42 μm, a size Dv50 of 106 μm and a size Dv90 of 178 μm, devoid of fillers and additivated with flow agent (TS610 sold by Cabot Corporation), is sieved at 160 μm before undergoing a sintering process by passing through an EOS Formiga P100 machine. Test specimens are produced at a build temperature of 103.5° C. and with a laser energy of 350 mJ/mm³, which makes it possible to obtain a good definition and also optimum mechanical properties. The powder of the bed which has not been touched by the electromagnetic radiation is, after cooling, again sieved at 160 μm.

The results are presented below:

TABLE 5

| | % by weight passing 160 μm |
|---|---|
| Formulation | sieve after machine passage |
| PEBA + 0.2% flow agent | less than 10% |
| PEBA + 0.6% flow agent | 50% |
| PEBA + 0.8% flow agent | 98% |
| PEBA + 1% flow agent | 100% |

It is observed that the addition of 0.2% by weight of flow agent does not make it possible to have good recyclability of the powder. However, when the flow agent is added at a content of greater than or equal to 0.3% by weight, the powder agglomerates less and the recyclability of the powder thus increases significantly. The addition of 1% by weight of flow agent makes it possible to achieve the complete maximum recyclability of the powder.

### Example 7

A laser sintering process is carried out on an EOS Formiga P100 machine (build temperature of 103.5° C., laser energy of 350 mJ/mm³) with the PEBA powder of example 6. 1 BA test specimens for carrying out tensile tests and test specimens for measuring the Charpy impact strength at ambient temperature and at −30° C., which are notched after sintering, are obtained.

The results are presented below:

TABLE 6

| | | | | Notched |
|---|---|---|---|---|
| | | Elongation at | Notched | Charpy |
| | | break test | Charpy test | test |
| | | specimen 1BA | specimen at | specimen |
| Formulation | Modulus | XY | ambient T | at −30° C. |
| PEBA + 0.3% | 50 MPa | 770% | No fracture | No |
| flow agent | | | | fracture |
| PEBA + 1.0% | 50 MPa | 710% | No fracture | No |
| flow agent | | | | fracture |

The elongation at break was measured according to the standard ISO 527-2 1BA.

The measurement of Charpy impact strength was carried out according to the standard ISO 179/1eA (at 23° C. and at −30° C.).

It is observed that the presence of the flow agent in an amount of from 0.3% to 1.0% by weight does not harm the mechanical properties of the parts obtained by laser sintering.

### Example 8

PEBA granules (same characteristics as in example 1) are compounded with 20% by weight of dolomite as pulverulent filler and then ground with a Mikropul 2DH hammer mill, and subsequently the powder is sieved at 160 μm. The powder has a size Dv10 of 33 μm, a size Dv50 of 62 μm and a size Dv90 of 111 μm.

A similar powder is produced without compounding with fillers. 0.3% by weight of a flow agent (TS610) is subsequently added to the two powders obtained.

A sintering process was carried out starting from these powders, on a Formiga P100 machine (sold by EOS) under optimized conditions (build temperature of 105° C., laser energy of 350 mJ/mm³).

The results are presented below:

TABLE 7

| | Modulus | Elongation at break test |
|---|---|---|
| Composition | (MPa) | specimen 1BA XY (%) |
| PEBA + 0.3% flow agent | 50 | 770% |
| PEBA + 20% dolomite + | 50 | 350% |
| 0.3% flow agent | | |

It is observed that, when pulverulent fillers are present in the PEBA particles in a significant content, the three-dimensional articles are obtained with damaged mechanical properties, in particular with a reduced elongation at break, in comparison with a three-dimensional article obtained from a composition not comprising pulverulent fillers in the PEBA particles.

1. A composition comprising a powder of copolymer comprising polyamide blocks and comprising polyether blocks, the copolymer being in the form of particles having a content of pulverulent fillers of from 0% to 10% by weight and the copolymer having a ratio by weight of the polyamide blocks to the polyether blocks of less than or equal to 0.7, the polyamide blocks having a number-average molar mass of less than or equal to 1000 g/mol; and the composition comprising a flow agent at a content of greater than or equal to 0.3% by weight.

2. The composition as claimed in claim 1, in which the polyamide blocks have a number-average molar mass of less than or equal to 900 g/mol.

3. The composition as claimed in claim 1, in which the ratio by weight of the polyamide blocks to the polyether blocks is less than or equal to 0.65.

4. The composition as claimed in claim 1, in which the flow agent is present at a content of less than or equal to 2% by weight.

5. The composition as claimed in claim 1, in which the flow agent is chosen from the group consisting of: silicas, alumina, glassy phosphates, glassy borates, glassy oxides, titanium dioxide, calcium silicates, magnesium silicates, talc, mica, kaolin, attapulgite and their mixtures.

6. The composition as claimed in claim 1, in which the particles of the powder have a size Dv10 of greater than or equal to 30 μm.

7. The composition as claimed in claim 1, in which the particles of the powder have a size Dv90 of less than or equal to 250 μm.

8. The composition as claimed in claim 1, in which the particles of the powder have a size Dv50 of from 80 to 150 μm.

9. The composition as claimed in claim 1, in which the copolymer exhibits an instantaneous hardness of from 20 to 75 Shore D.

10. The composition as claimed in claim 1, in which the polyamide blocks of the copolymer are blocks of polyamide 11, or of polyamide 12, or of polyamide 6, or of polyamide 1010, or of polyamide 1012, or of polyamide 610; and/or in which the polyether blocks of the copolymer are blocks of polyethylene glycol, of polypropylene glycol or of polytetrahydrofuran.

11. The composition as claimed in claim 1, in which the polyamide blocks of the copolymer are blocks of polyamide 11, or of polyamide 12, or of polyamide 1010, or of polyamide 1012; and/or in which the polyether blocks of the copolymer are blocks of polyethylene glycol, of polypropylene glycol or of polytetrahydrofuran.

12. The composition as claimed in claim 1, in which the polyether blocks have a number-average molar mass of from 400 to 3000 g/mol.

13. A process for the preparation of the composition as claimed in claim 1, comprising:
the provision of a copolymer comprising polyamide blocks and comprising polyether blocks and the grinding of this, and
the bringing of the copolymer into contact with a flow agent.

14. The process as claimed in claim 13, in which the copolymer is brought into contact with the flow agent before the grinding.

15. The process as claimed in claim 13, in which the grinding is a cryogenic grinding.

16. The process as claimed in claim 13, in which the copolymer is provided in the form of granules.

17. The process as claimed in claim 13, in which the particles resulting from the grinding are sieved, the sieve oversize being recycled to the grinding.

18. The use of the composition as claimed in claim 1, for the layer-by-layer building of a three-dimensional article by sintering of the composition brought about by electromagnetic radiation.

19. A three-dimensional article manufactured from the composition as claimed in claim 1.
